(19) United States
(12) Patent Application Publication
(10) Pub. No.: US 2010/0058980 A1
(43) Pub. Date: Mar. 11, 2010

(54) Roller Applicator

(76) Inventor: Rory Heard, Cape Town (ZA)

Correspondence Address: GOLD & RIZVI, P.A., 600 N. PINE ISLAND ROAD, SUITE 450, PLANTATION, FL, 33324-1311, US

(21) Appl. No.: 12/093,625

(22) PCT Filed: Feb. 14, 2007
(86) PCT No.: PCT/ZA07/00015

§ 371 Date: May 14, 2008

(30) Foreign Application Priority Data
Feb. 15, 2006 (ZA) ZAP2006/1350

(51) Int. Cl. B05C 17/02

(52) U.S. Cl. 118/258

(57) ABSTRACT

A roller applicator for paint and other applications which comprises a shaft, a circular cylinder, end caps for the cylinder forming hubs that rotate on the shaft and a handle connected to the shaft, characterized in that the cylinder carries a material that presents a surface having a multiplicity of tiny hooks and a fabric is provided which presents a fibrous surface on an inner side and is dimensioned to fit on the cylinder when wrapped around it. The fabric can be removed after use and discarded and anew fabric added for further use of the roller applicator.

### FIELD OF THE INVENTION

This invention lies in the field roller applicators. Including paint rollers and roller applicators for other substances.

### BACKGROUND

Paint rollers have become widely known and used, although not displacing paint brushes entirely and rollers may be used also for applying glue over large areas e.g. for wall-papering, applying damp seal, resin application to glass fiber mat and other applications. As with paint brushes the cleaning of paint rollers after use is a messy and tedious business, especially with oil-based paints and often the job is not well or completely done, leading to ongoing deterioration of the roller. If anything a roller may be more difficult to clean well and thus avoid hardening of the roller surface than brushes, which is an adverse comparison with paint brushes.

### THE INVENTION

A roller applicator in accordance with this invention comprises a shaft, a circular cylinder, end caps or other formations for the cylinder forming hubs that rotate on the shaft and a handle connected to the shaft, characterized in that the cylinder carries a material that presents a surface having a multiplicity of tiny hooks and a fabric is provided which presents a fibrous surface on an inner side and is dimensioned to fit on the cylinder when wrapped around it.

A roller applicator in accordance with another aspect of this invention includes a circular cylinder, means for rotational mounting on a shaft with a handle connected to the shaft, characterized in that the cylinder carries a material that presents a surface having a multiplicity of tiny hooks and a fabric is provided which presents a fibrous surface on an inner side and is dimensioned to fit on the cylinder when wrapped around it.

The end caps may be loose or integral with the cylinder, or one of them loose and one integral, generally it is preferable for the cylinder to be hollow, both for cost considerations and weight.

The fibrous surface is adapted to be engaged and held by the tiny hooks and the fibrous surface may be of a mesh or woven character, e.g. a course mesh.

The inverse arrangement of a multiplicity of tiny hooks provided on the inner side of the fabric and the fibrous surface provided on the cylinder is included within the scope of this invention.

The surface having hooks and the coarse mesh surface have been commercially manufactured and sold under the trade name of “Velcro” and this is suitable for use in this invention.

The fabric may have a thickness and consistency adapted to suit it well to application of paint or other substance, according to the thickness and viscosity of the substance concerned. A fabric that is suitable for most if not all applications may be provided as a standard. The outer surface of the fabric may have a textured surface by which is meant a “fluffy”-like surface as in the case of for example sheep's wool or a textured surface somewhat like a toweling or carpet-like surface or it may be merely a fabric of suitable thickness for the substance to be applied by it. A fabric that is typically a synthetic polyester-based mix is suitable.

In accordance with a preferred embodiment of the invention the fabric when laid open and flat has an outline shape of a non-rectangular parallelogram. To fit the cylinder when rolled around the cylinder and held by the hooks the distance between two sides is equal to the length of the cylinder and the distance normal to that is equal to the circumference of the cylinder. This shape allows the join line of the fabric on the cylinder to follow a helical path, thus avoiding a line parallel to the axis of the cylinder that may cause a line of poor paint application or a tendency for the fabric to unroll off the cylinder during use. The diagonal join in fact distributes the paint more evenly (with conventional rollers the paint often gathers on the ends leaving track marks on either end of the roller's path).

The ability to remove the fabric allows replacement of it after use or if washing is desired easier washing of it as it is off the roller, it could be washed in a washing machine, in the case of water based paints and other substances.

In particular the fabric may be characterized by having a course mesh backing, e.g. a brushed nylon backing and a fabric pile of a required depth; the depth of pile affects the amount of paint that can be held on the paint roller during use and the capacity to handle well particular thicknesses and viscosities of paint or other substances.

Preferably the material with the multiplicity of tiny hooks is applied to the cylinder in a helically wound strip, for example glued to the cylinder surface. The cylinder may conveniently be made by extrusion of a polymer and cut to length, it could also be made by injection of polymer in a die or mould.

### THE DRAWINGS

The invention is more fully described by way of example, with reference to the drawings, in which:

FIG. 1 is a perspective view of the roller applicator dismantled,

FIG. 2 is a plan of the fabric that is wrapped around the roller laid out flat,

FIG. 3 is a side elevation of the fabric,

FIG. 4 is a side view of the cylinder, and

FIG. 5 is an end view of the cylinder.

### THE PREFERRED EMBODIMENTS

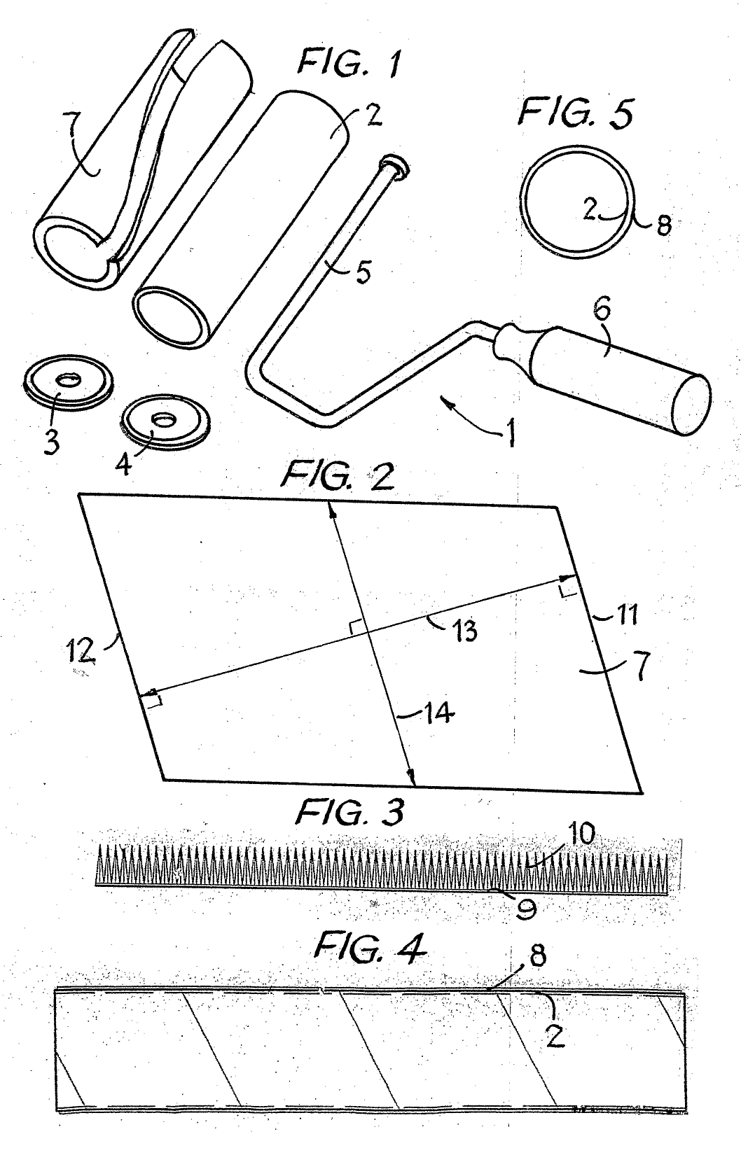

As shown in FIG. 1, the roller applicator 1 comprises a circular cylinder 2, end caps 3 and 4 for the cylinder forming hubs that rotate on a shaft 5, the shaft provided to carry the hubs and cylinder and a handle 6 connected to the shaft, and a fabric 7 dimensioned to fit on the cylinder when wrapped around it.

The cylinder carries a material 8 that presents a surface having a multiplicity of tiny hooks and the fabric presents a course mesh surface on an inner side, a “Velcro” (trademark) system. The material is applied to the cylinder in a helically wound strip, as shown in the view of FIG. 4, glued to the cylinder surface.

The fabric has a brushed nylon backing 9 and a fabric pile 10.

The fabric when laid open and flat has an outline shape of a non-rectangular parallelogram, as shown in the view of FIG. 2. To fit the cylinder when rolled around the cylinder and held by the hooks the distance 13 between two sides 11 and 12 is equal to the length of the cylinder and the distance 14 normal to that (parallel to the sides 11 and 12 is equal to the circumference of the cylinder.

In use the fabric may be removed when a paint colour change arises and a new fabric wrapped around the cylinder for the new colour. The used fabric can be rinsed when convenient for re-use, if required. The rinsing is easier and more effective than in the case of conventional paint rollers which have to be washed on the cylinder.

To apply a fabric to the cylinder the fabric is placed on the roller with its edge 12 along the edge of the cylinder and is then firmly pressed around the cylinder.

### REFERENCE NUMERALS

1 applicator roller
2 cylinder
3 end cap
4 end cap
5 shaft
6 handle
7 fabric
8 material
9 nylon backing
10 fabric pile
11 side
12 side
13 length
14 breadth

1. A roller applicator which comprises a shaft, a circular cylinder, end formations for the cylinder forming hubs that rotate on the shaft and a handle connected to the shaft, characterized in that the cylinder carries a material that presents a surface having a multiplicity of tiny hooks and a fabric is provided which presents a fibrous surface on an inner side and is dimensioned to fit on the cylinder when wrapped around it.

2. A roller applicator which invention includes a circular cylinder, means for rotational mounting on a shaft with a handle connected to the shaft, characterized in that the cylinder carries a material that presents a surface having a multiplicity of tiny hooks and a fabric is provided which presents a fibrous surface on an inner side and is dimensioned to fit on the cylinder when wrapped around it.

3. A roller applicator as claimed in claim 2, in which the end formations are end caps and the cylinder is a hollow cylinder.

4. A roller applicator as claimed in any one of claims 1 to 3, in which the fibrous surface is of a mesh or woven character.

5. A roller applicator as claimed in either one of claims 1 to 3, in which the fibrous surface is of a brushed nylon character.

6. A roller applicator as claimed in any one of claims 1 to 5, in which the inverse arrangement is adopted of a multiplicity of tiny hooks provided on the inner side of the fabric and the fibrous surface provided on the cylinder.

7. A roller applicator as claimed in any one of claims 1 to 6, in which the fabric when laid open and flat has an outline shape of a non-rectangular parallelogram and the distance between two sides is equal to the length of the cylinder and the distance normal to that is equal to the circumference of the cylinder.

8. A roller applicator as claimed in any one of claims 1 to 7, in which the fabric is characterized by having a course mesh backing and a fabric pile of a required depth.

9. A roller applicator as claimed in any one of claims 1 to 8, in which the material with the multiplicity of tiny hooks is applied to the cylinder in a helically wound strip.

10. A roller applicator as described herein and as illustrated in the drawings.
